(19) United States
(12) Patent Application Publication
(10) Pub. No.: US 2018/0164220 A1
(43) Pub. Date: Jun. 14, 2018

(54) DEVICE FOR MEASURING ELECTROLYTE IONS USING OPTODES AND USES THEREOF

(71) Applicant: Samsung Electronics Co., Ltd., Suwon-si (KR)

(72) Inventors: Jin-young Park, Pohang-si (KR); Youn-suk Choi, Yongin-si (KR); Hye-jung Seo, Chuncheon-si (KR); Jae-yeon Jung, Hwaseong-si (KR); Young-ki Hahn, Seoul (KR); Hyo-young Jeong, Seoul (KR); Joon-hyung Lee, Yongin -si (KR); Soo-suk Lee, Suwon-si (KR)

(21) Appl. No.: 15/889,484

(22) Filed: Feb. 6, 2018

Related U.S. Application Data
(62) Division of application No. 14/081,049, filed on Nov. 15, 2013.

(30) Foreign Application Priority Data
Dec. 11, 2012 (KR) 10-2012-0143830

(51) Int. Cl. G01N 21/75; G01N 21/78; G01N 21/77

(52) U.S. Cl. CPC G01N 21/75; G01N 2021/7796; G01N 21/78

(57) ABSTRACT

Provided is a device for measuring electrolyte ions that is capable of providing a uniform pH environment in the region of an optode, and a method of measuring electrolyte ion concentration using the device.

### CROSS-REFERENCE TO RELATED APPLICATIONS

This application is a divisional of U.S. patent application Ser. No. 14/081,049 filed on Nov. 15, 2013, which claims the benefit of Korean Patent Application No. 10-2012-0143830, filed on Dec. 11, 2012 in the Korean Intellectual Property Office, the entire disclosures of which are hereby incorporated by reference.

### BACKGROUND

### 1. Field

The present disclosure relates to devices for measuring electrolyte ions using optodes and uses thereof.

### 2. Description of the Related Art

Methods of measuring electrolyte ions include the use of analyzers such as an ion-selective electrode (ISE), a flame emission spectrophotometer (FES), an atomic absorption spectrophotometer (AAS), and the like. The FES involves quantitative and qualitative analysis after measuring light emission and is relatively inexpensive, but is large and requires flame gas. In current practice, FES, AAS, and enzyme methods are rarely used in general examination clinics due to cumbersome measurements; ISE is the most commonly used method. ISE measures an electrolyte ion concentration by measuring a change in potential between a working electrode and a reference electrode. In comparison to other methods, ISE is not affected by sample turbidity. Both direct analysis of whole blood and measurement of the concentration of electrolyte ions are possible using only a small blood sample . However, regular replacement of various types of reagents and various consumable supplies is needed to maintain the analyzer; hence, use of ISE is cumbersome.

Examples of positive ions in an electrolyte solution include sodium (Na⁺), potassium (K⁺), calcium (Ca²⁺), magnesium (Mg²⁺), and the like, and examples of negative ions in an electrolyte solution include chlorine (Cl⁻), hydrochloric acid (HCO₃⁻), sulfate (SO₄²⁻), and the like. The concentration of ions in blood is normally relatively constant due to homeostasis and metabolic control processes in the body, but may become imbalanced due to, for example, kidney or endocrine diseases or treatment with particular drugs. By measuring the electrolyte ion concentration in blood, such diseases may be diagnosed and treated.

### SUMMARY

Provided are devices for measuring electrolyte ions in samples using optodes.

Provided are methods of measuring electrolyte ions using devices for measuring electrolyte ions.

Additional aspects will be set forth in part in the description which follows and, in part, will be apparent from the description, or may be learned by practice of the presented embodiments.

According to an aspect of the present invention, provided are devices for measuring electrolyte ions including optodes located on a first substrate and a buffer located on a second substrate facing the first substrate.

The term “electrolyte” as used herein refers to a material including free ions capable of making the material conductive. Examples of the electrolyte include an acid, a base, or a salt. The term “salt” as used herein refers to an ionic compound prepared by a neutralization reaction of an acid and a base. The ionic compound consists of positive ions and negative ions, thereby producing an electrically neutral product. A solution including a molten salt or a dissolved salt such as aqueous NaCl is referred to as an electrolyte. An electrolyte acid solution or an electrolyte base solution may have a pH of about 3 to about 9. The acid may be organic or inorganic. The organic acid may be formic acid, acetic acid, lactic acid, citric acid, oxalic acid, or a mixture thereof. The inorganic acid may be hydrochloric acid, nitric acid, phosphoric acid, sulfuric acid, boric acid, or a mixture thereof. The base may be organic or inorganic solution. The organic solution may be pyridine, methylamine, imidazole, histidine, or a mixture thereof. The inorganic base may be ammonia, ammonium hydroxide, ammonium carbonate, or a mixture thereof.

The optode includes an indicator material capable of changing color when it reacts with an electrolyte including ions. The optode may include an optical ion sensor. The optode may include an ionophore. The ionophore may be a target ionophore or an indicator ionophore such as a chromoionophore. The indicator ionophore may be a pH indicating chromoionophore or a pH indicating fluoroinophore. The optode may include a target inophore which complexes with the target ion when present, and an indicator ionophore which provides an indication of such complexing, such as by a color change. The target ionophore is capable of complexing with the target ion and the indicator ionophore is capable of giving rise to a dectectable signal following complexation of the target ion in the sample. Each optode may include a plurality of target ionophores and indicator ionophores uniformly. Also, each optode may include the same target ionophore or different target ionophores for detecting different ions. The optode may further include a material selected from the group consisting of a polymer, a plasticizer, an additive, or a mixture thereof. The optode are formed by combining indicators with the polymer. The polymer may be polystyrene, polyparamethylsytrene, polymethylmethacrylate, polyethylmethacrylate, polyethylene dimethacrylate, polyvinyldene chloride, polyvinyl chloride, polypropylene, methyl methacrylate-styrene copolymer, polyacolein, polybutadiene, polydivinylbenzen, poly-L-lysine, polyethylenimine, polyacrylic acid, polyvinyl alcohol, polyacrylamide, or polyurethane. The plsticizer may be included in the optode optionally and be bis(2-ethylhexyl)sebacate (DOS) or o-nitrophenyloctylether (NPOE). The additive may be used in the optode to enhance the extraction of target ion from the aqueous sample or migration of target ion into the organic particle phase. The additive may be NaTm(CF₃)₂PB (sodium tetrakis[3,5-bos(trifluormethyl)phenyl]borate, ETH500 (tetradodecylammonium tetrakis (p-chloro-phenyl)borate), or KTpCIPB (potassium tetrakis (4-chlorophenyl)borate). The target ion may be sodium, potassium, calcium, amonium, or chloride. The ionophore may include a potassium ionophore III (BME-44), sodium ionophore IV, sodium ionophore V, sodium ionophore VI, calcium ionophore III, calcium ionophore IV, chloride ionophore III, ornitrite ionophore I. The target ionphore may be ETH 1001 ([(−)-R,R)-N,N′-Bis-[11-(ethoxycarbonyl) undecyl]-N,N′-4,5-tetramethyl-3,6-dioxaoctane-diamide; Diethyl N,N′-[(4R,5R)-4,5-dimethyl-1,8-dioxo-3,6-dioxaoctamethylene]bis(12-methylam inododecanoate)]), chloro(octaethylporphyrinatro)indium, monactin, ETH2120 ([N,N,N′,N′-Tetracyclohexyl-1,2-phenylenedioxydiacetamide], ETH4120 ([4-Octadecanoyloxymethyl- N,N,N′,N′-tetracyclohexyl-1,2-phenylenedioxydiacetamide]), or valinomycin. The indicator ionophore may be ETH 5350 ([9-(Diethylamino)-5-](2-octyldecyl)imino]benzo[a]phenoxazine]), ETH2439 ([9-Dimethylamino-5-[4-16-butyl-2,14-dioxo-3,15-dioxaeicosyl)phenylimino]benzo[a]phenoxazine]), ETH 5294 ([9-(Diethylamino)-5-octadecanoylimino-5H-benzo[a]phenoxazine]), or ETH 2412 ([5-Octadecanoyloxy-2-(4-nitrophenylazo)phenol]).

The buffer may be selected from the group consisting of HEPES buffer, MES buffer, ADA buffer, bis-tris buffer, tris buffer, formate buffer, sodium phosphate buffer, citrate buffer, MOPS buffer, ACES buffer, and a mixture thereof. A pH of the buffer may be about 2 to about 10, about 2.5 to about 9.5, about 3 to about 9, about 3.5 to about 8.5, about 4 to about 8, about 4.5 to about 7.5, about 5 to about 7, or about 5.5 to about 6.5.

The device may include a plurality of optodes and/or a plurality of the buffers, optionally in one or more arrays. The device may include different optodes for detecting different electrolyte ion. The term “array” as used herein refers to an arrangement of the optodes and/or the buffers on the first substrate and/or the second substrate. The array may have any arrangement, for example, a uniform arrangement (e.g. parallel rows) or a non-uniform or random arrangement.

The device for measuring electrolyte ions may further include one or more spacers between the first substrate and the second substrate. The spacers are positioned such that the spacers together with the surfaces of the first and second substrates upon which the one or more optodes and buffers are disposed define a cavity or channel, wherein the optodes and buffers are within the cavity or channel. The dimension of the cavity or channel may be about 1.2 mm×1.6 mm. The diameter or dimension between the spacers may be greater than the width of the surface on which the optode is located. In other words, the spacers are separated by a distance greater than the size of the optode, so that the optode (and buffer) is generally positioned between the spacers. The size of the optode (and/or buffer) may be about 1 mm×1.4 mm.

The device for measuring electrolyte ions may further include an inlet. The inlet may be located on the second substrate. The device for measuring electrolyte ions may further include a filter. The filter may be located on the second substrate.

The device for measuring electrolyte ions may further include shielding materials on the first substrate and/or the second substrate. The device for measuring electrolyte ions may further include shielding materials around the optodes. The shielding materials may be selected from the group consisting of polyethylene, polypropylene (PP), polyvinyl chloride (PVC), polyvinyl alcohol (PVA), polystyrene (PS), polyethylene terephthalate (PET), polyester, polyacryl, polyurethane, epoxy, and a mixture thereof. The polyethylene may be selected from the group consisting of very low density polyethylene (VDLPE), linear low density polyethylene (LLDPE), low density polyethylene (LDPE), medium density polyethylene (MDPE), high density polyethylene (HDPE), and a mixture thereof. After the optode is coated on the first substrate, the shielding material may be coated around the optode. The shielding material may be relatively hydrophobic compared to the material of the optode, and have a higher water contact angle than the material of the optode. The water contact angle of the shielding material may be about 30° to about 60°, about 35° to about 60°, about 40° to about 60°, about 45° to about 60°, about 50° to about 60°, or about 55° to about 60°.

Alternatively, or in addition, the shielding material may include paint. The paint may be hydrophobic or hydrophilic.

The first substrate may further include a depression. The optode may be included in the depression. The depression may be formed around the optode, for instance, partially or completely surrounding a periphery of the optode while still allowing at least a portion of the optode to be exposed to contact a sample.

The first substrate may further include a protrusion. The protrusion may be formed around the optode. A height of the protrusion may be about 1 μm to about 100 μm, about 2 μm to about 90 μm, about 4 μm to about 80 μm, about 6 μm to about 70 μm, about 8 μm to about 60 μm, about 10 μm to about 50 μm, about 12 μm to about 40 μm, about 14 μm to about 20 μm, or about 15 μm to about 18 μm. The protrusion may be relatively hydrophobic compared to the material of the optode, and have a higher water contact angle than the optode. The water contact angle may be about 30° to about 60°, about 35° to about 60°, about 40° to about 60°, about 45° to about 60°, about 50° to about 60°, or about 55° to about 60°. To have this contact angle, the material for the protrusion may be suitably selected by a person of ordinary skill in the art to which the invention pertains. The material for the protrusion may be the shielding material.

The buffer may further include an additive. The additive may be selected from the group consisting of sodium dodecyl sulfate (SDS), cetyltrimethylammonium bromide (CTAB), Sodium dodecylbenzene sulfate, 3-[(3-cholamidopropyl)dimethylammonio]-1-propanesulfonate (Chaps), 3-[(3-cholamidopropyl)dimethylammonio]-2-hydroxy-1-propanesulfonate (Chapso), Triton X-100 (polyethylene glycol p-(1,1,3,3-tetramethylbutyl)-phenyl ether), Triton X-405 (polyethylene glycol tert-octylphenyl ether), Triton X-114 (polyethylene glycol p-(1,1,3,3-tetramethylbutyl)-phenyl ether), polyethylene glycol (PEG), sucrose, sorbitol, glycerol, dextran, chitosan, cellulose, lactose, xylitol, mannitol, maltose, inositol, trehalose, glucose, polyvinylpyrrolidone (PVP), polyacrylamide (PAA), polyvinylalcohol (PVA), poly(vinyl acetate), poly(methacrylic acid) (PMAA), and a mixture thereof.

Concentration of the additive may be about 0% to about 25%, about 0% to about 20%, about 0% to about 15%, about 0% to about 10%, about 0% to about 5%, about 0% to about 3%, about 0.01% to about 25%, about 0.01% to about 20%, about 0.01% to about 15%, about 0.01% to about 10%, about 0.01% to about 5%, or about 0.01% to about 3% of the buffer. Concentrations of STD, CTAB, sodium dodecylbenzensulfate, Chaps, or Chapso may be about 0% to about 10%, about 0% to about 8%, about 0% to about 6%, about 0% to about 5%, about 0% to about 4%, about 0% to about 3%, about 0% to about 2%, about 0.01% to about 10%, about 0.01% to about 8%, about 0.01% to about 6%, about 0.01% to about 5%, about 0.01% to about 4%, about 0.01% to about 3%, or about 0.01% to about 2% of the buffer. Concentrations of the PEG, sucrose, sorbitol, glycerol, dextran, chitosan, or cellulose may be about 0% to about 15%, about 0% to about 13%, about 0% to about 10%, about 0% to about 8%, about 0% to about 5%, about 0% to about 3%, about 0.01% to about 15%, about 0.01% to about 13%, about 0.01% to about 10%, about 0.01% to about 8%, about 0.01% to about 5%, or about 0.01% to about 3% of the buffer. Concentrations of the PVP, PAA, PVA, poly(styrene sulfonic acid), poly(vinyl acetate), or poly(methacrylic acid) may be about 0% to about 25%, about 0% to about 20%, about 0% to about 15%, about 0% to about 13%, about 0% to about 10%, about 0% to about 8%, about 0% to about 5%, about 0% to about 3%, about 0.01% to about 25%, about 0.01% to about 20%, about 0.01% to about 15%, about 0.01% to about 13%, about 0.01% to about 10%, about 0.01% to about 8%, about 0.01% to about 5%, or about 0.01% to about 3% of the buffer. The foregoing percent compositions are by weight.

The device for measuring electrolyte ions may further include a measuring part. The measuring part may be a region which includes optode disposed on a surface of a first substrate and a buffer disposed on a surface of a second substrate. The optode on the surface of the first substrate faces the buffer on the surface of the second substrate. The measuring part may be phototrasparent. A color change of the optode in the measuring part may be optically measured by instrumentation such as detector, light source, or other electronics.

According to another aspect of the present invention, there is provided a method of measuring an electrolyte ion concentration by flowing a sample into the device for measuring electrolyte ions; and detecting a reaction between the optode in the device for measuring electrolyte ions and the sample, wherein the device for measuring electrolyte ions includes the optode located on a first substrate and a buffer located on a second substrate facing the first substrate.

Regarding the above method, the method may further include passing the sample through a filter positioned in an inlet of the device. The device for measuring electrolyte ions, the optode, and the buffer are the same as described above. The buffer may further include the additive. The additive is the same as described above. All other aspects of the device used in accordance with the method are as previously described.

The device may be prepared by any suitable method. The optode, the buffer and/or the shielding material may be deposited or coated on a substrate, for instance, by a drop method, screen printing method, a pick and place method through a bar coating method, an inkjet method, and a spin coating method, or a combination of such techniques. The drop method may be dropping the optode and the buffer into its corresponding location in a first and/or second substrate. The shielding material can be deposited or coated on a substrate by screen printing method. The pick and place method through a bar coating method use a human or robot arm to pick bar coating such as Mayer Bar coating which include the optode and the buffer and then place it into its corresponding location in a first and/or second substrate.

According to the device for measuring electrolyte ions and/or the method of measuring the electrolyte ion concentration according to an aspect of the present invention, may provide a uniform pH environment to the optode without a separate pretreatment of the sample when measuring electrolyte ions using the optode, because the buffer is located inside the device for measuring electrolyte ions.

According to the device for measuring electrolyte ions and/or the method of measuring the electrolyte ion concentration according to an aspect of the present invention, a decrease in sensitivity of measuring the electrolyte ions due to passage of time may be prevented.

According to the device for measuring electrolyte ions according to an aspect of the present invention, a minimization of the device for measuring electrolyte ions is possible by selecting a measuring method using the optode, because a complex electrode structure is not needed.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram that shows main components of a device for measuring electrolyte ions, according to an embodiment of the present invention;

FIG. 2 is a diagram that shows a device for measuring electrolyte ions that further includes a filter in a flowing inlet of the device for measuring electrolyte ions, according to an embodiment of the present invention; and

FIGS. 3 and 4 are diagrams that respectively show optodes coated on a top surface of a first substrate of a device for measuring electrolyte ions, according to an embodiment of the present invention, and buffers coated on a bottom surface of a second substrate of the device for measuring electrolyte ions, according to an embodiment of the present invention.

FIG. 5 is a diagram that shows a first substrate of a device for measuring electrolyte ions, according to an embodiment of the present invention, further including a shielding material around an optode coating on the first substrate.

FIG. 6 is a diagram that shows a first substrate of a device for measuring electrolyte ions, according to an embodiment of the present invention, further including a shielding material around an optode coating on the first substrate.

FIG. 7 is a diagram that shows depressions included in a first substrate of a device for measuring electrolyte ions, according to an embodiment of the present invention.

FIG. 8 is a diagram that shows protrusions included in a first substrate of a device for measuring electrolyte ions, and an optode coating having a shape of an initial meniscus, according to an embodiment of the present invention.

FIG. 9 is a diagram that shows protrusions included in a first substrate of a device for measuring electrolyte ions, and an optode coating having a shape of an equilibrium meniscus, according to an embodiment of the present invention.

FIG. 10 is a graph that shows difference in absorbance measured according to potassium ion concentrations in samples by using the device for measuring electrolyte ions.

FIG. 11 is a graph that shows a difference in signal magnitudes of absorbance measured according to a potassium concentration in a sample using a device for measuring electrolyte ions coated with a buffer and a device for measuring electrolyte ions without the buffer.

FIG. 12 is a graph that shows a result of measuring absorbance signal at different concentrations of potassium ions in a device for measuring electrolyte ions according to passage of time.

FIG. 13 is a graph that shows a result of measuring absorbance signal at different concentrations of potassium ions in a device for measuring electrolyte ions according to passage of time after replacing a shielding paint material.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

FIG. 1 shows main components of a device for measuring electrolyte ions according to an embodiment of the present invention. As shown in FIG. 1, the device for measuring electrolyte ions 100 may include a first substrate 110, a second substrate 120 separated from the first substrate 110, and a spacer located in a gap between the first substrate 110 and the second substrate 120. Also, the device for measuring electrolyte ions 100 may include an internal cavity surrounded by the first substrate 110, the second substrate 120, and the spacer 130. The internal cavity may be used as a chamber or a channel of the device for measuring electrolyte ions 100.

A shielding material 230 may be coated on a side of the first substrate 110 and/or the second substrate 120. The shielding material 230 is for preventing leaching of any material along the first substrate 110 and the second substrate 120. The shielding material 230 is the same as described above.

The device for measuring electrolyte ions 100 may include an optode 210 located on the first substrate 110 and a buffer 220 located on the second substrate 120 facing the first substrate 110. The optode 210 may be located on one side of the first substrate 110. The optode 210 may be coated on one side of the first substrate 110. The buffer 220 may be located on one side of the second substrate 120. The optode 210 located on the first substrate 110 and the buffer 220 located on the second substrate 120 may be facing each other. The buffer 220 may be coated on one side of the second substrate 120. The optode 210 and/or the buffer 220 may be located on surfaces of the first substrate 110 and/or the second substrate 120 coated with the shielding materials 230. The shielding material 230 is for preventing the optode 210 and/or the buffer 220 from leaching out. The coating is the same as described above. The diameter of closely located spacers 130 (A) may be larger than the largest diameter of the surface area of the optode 210 and/or the buffer 220. The diameter is for preventing leaching of any material including the optode through the spacers 130 by contacting the optode with the spacer 130.

In the present specification, the optode 210 may encompass a mixture including the optode material and a polymer, plasticizer, or other additive. In the present specification, the buffer 220 may encompass a mixture including the buffer and an additive. The additive is the same as described above. The optode 210 and the buffer 220 are located in the internal cavity and may participate in a reaction for measuring the electrolyte ions. Hereinafter, the internal cavity is referred to as a “reaction part.” The buffer 220 may provide a uniform pH in the internal cavity by reacting with a sample flowed into the internal cavity. The uniform pH in the internal cavity may provide a uniform maintenance of an initial protonation state of a chromoionophore in the optode 210. The electrolyte ion concentration of the sample may be measured by reacting the sample with the optode 210.

The first substrate 110 and the second substrate 120 may be a material selected from the group consisting of polydimethylsiloxane (PDMS), cyclic olefin copolymer (COC), polymethylmethacrylate (PMMA), polycarbonate (PC), polypropylene carbonate (PPC), polyether sulfone (PES), 2-hydroxyethyl methacrylate (HEMA), polyethylene terephthalate (PETC), and a mixture thereof.

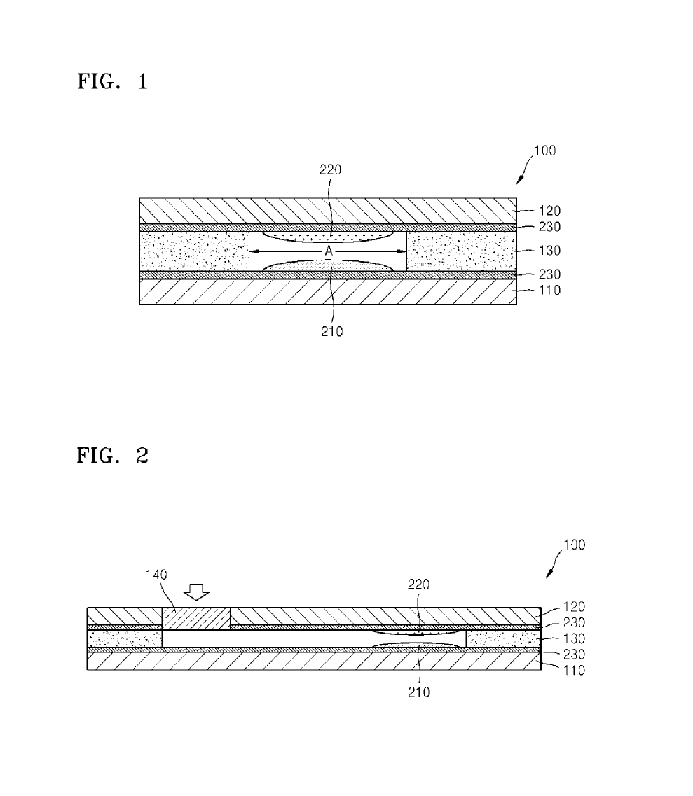

FIG. 2 shows a device for measuring electrolyte ions that further includes a filter in a flowing inlet of the device for measuring electrolyte ions, according to an embodiment of the present invention. As shown in FIG. 2, the device for measuring electrolyte ions 100 may further include an flowing inlet (not shown) for injecting the sample into the device for measuring electrolyte ions 100. The sample may be a sample including a target material. The filter 140 may be located at the flowing inlet. The target material may pass through the filter 140. The filter 140 used may be a filter generally used in the field to which the invention pertains. For example, when blood flows into the device for measuring electrolyte ions 100, the filter 140 may pass blood plasma through the reaction part. The sample may flow into the device for measuring electrolyte ions using a pump. The pump may transport the sample using a pressure. The pump used may be any pump used in the field to which the invention pertains.

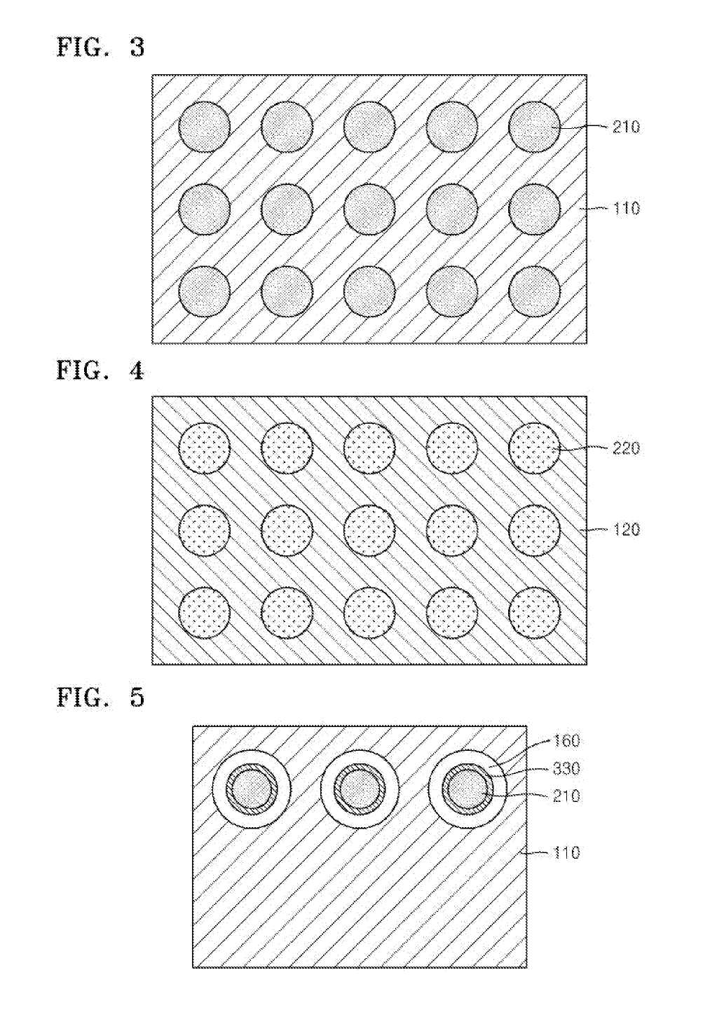

FIGS. 3 and 4 respectively show optodes coated on a top surface of the first substrate of the device for measuring electrolyte ions and buffers coated on a bottom surface of the second substrate of the device for measuring electrolyte ions, according to an embodiment of the invention. As shown in FIG. 3, the first substrate 110 may include a plurality of optodes 210. The plurality of optodes 210 may be an array of the plurality of optodes 210. As shown in FIG. 4, the second substrate 120 may include a plurality of buffers 220. The plurality of buffers 220 may be an array of the plurality of buffers 220. The plurality of optodes 210 coated on the first substrate 110 and the plurality of buffers 220 coated on the second substrate 120 may be identical. When the array of the plurality of optodes 210 and the array of the plurality of buffers 220 are separated and facing each other, the optodes 210 coated on the first substrate 110 and the buffers 220 coated on the second substrate 120 may be facing each other, and those optodes 210 and buffers 220 facing each other may form couples. The array of the plurality of the optodes 210 and/or the array of the plurality of the buffers 220 may vary depending on types of ions, types of the optodes 210, types of the buffers 220, a surface area of the first substrate 110, a surface area of the second substrate 120, a surface area of the optode 210 coated on the first substrate 110, and/or a surface area of the buffer 220 coated on the second substrate 120.

FIG. 5 shows the first substrate of a device for measuring electrolyte ions according to an embodiment of the present invention, further including a shielding material around an optode coating on the first substrate. As shown in FIG. 5, a surface of the first substrate 110 may further include the shielding material 330 around the optodes 210 coating on the surface of the first substrate. The shielding material 330 is for preventing parts of the optode 210 coatings from diffusing to the outside of the chamber or channel 160 defined by the substrates and spacers (not shown in FIG. 5). The optode may be dropped inside the shielding material 330 already screen-printed on the first substrate 110. The shielding material 330 may be coated separately from the optode 210 coating. The shielding material 330 may contact the optode 210 coating.

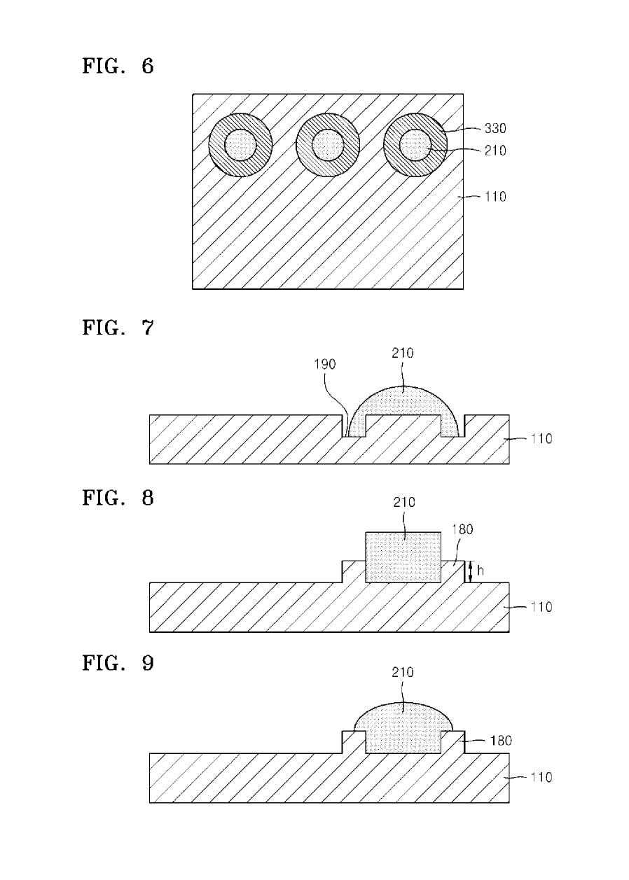

FIG. 6 shows the first substrate of the device for measuring electrolyte ions, according to an embodiment of the present invention, further including a shielding material around the optode coating on the first substrate. As shown in FIG. 6, a surface of the first substrate 110 may further include the shielding material 330 around the optodes 210 coating on the surface of the first substrate. The shielding material 330 may be coated around the optode 210 after coating the optode 210. The optode may be dropped inside the shielding material 330 already screen-printed on the first substrate 110. The shielding material 330 may be coated separately from the optode 210 coating. The shielding material 330 may contact the optode 210 coating. The coating may be performed using a printing method, for example a screen printing method. The printing method may include a double screen printing method. The shielding material 330 has a high water contact angle compared to the optode 210 and may allow the optode 210 coating to be uniform.

FIG. 7 shows depressions included in the first substrate of the device for measuring electrolyte ions according to an embodiment of the present invention. As shown in FIG. 7, the first substrate 110 may include a depression 190 on a surface of the first substrate 110. The depression 190 may be located partly or entirely external to the optode 210. In other words, the depression generally surrounds and defines the periphery of the optode, but the optode may partly or entirely fill the depression.

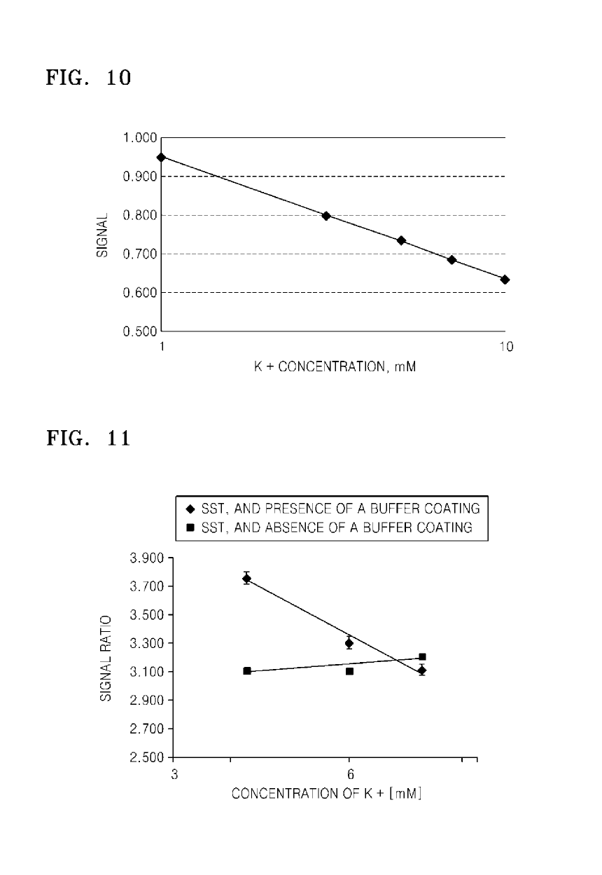

FIG. 8 shows protrusions included in the first substrate of the device for measuring electrolyte ions and an optode coating having a shape of an initial meniscus, according to an embodiment of the present invention. As shown in FIG. 8, the first substrate 110 may include protrusions 180 on a surface of the first substrate 110. The height (h) of the protrusions may be about 15 μm.

FIG. 9 shows protrusions included in the first substrate of the device for measuring electrolyte ions and an optode coating having a shape of an equilibrium meniscus, according to an embodiment of the present invention. As shown in FIG. 9, the optode 210 coating from the equilibrium meniscus may be located on top surfaces of the protrusions 180. Depending on a size of the contact angle of the optode 210 with respect to the protrusions 180, the meniscus shape of the optode 210 coating may vary. Regarding to the protrusions 180 having a high water contact angle relative to the optode 210, the protrusions 180 prevent the optode 210 from overstepping the boundaries of the protrusions 180 and enable the optode 210 to have a uniform shape after the optode 210 has been coated. The water contact angle of the protrusion may be about 30° to about 60 °.

### EXAMPLE 1

### Changes in Absorbance (Signal) at Different Potassium Ion Concentrations using the Device for Measuring Electrolyte Ions

3.4 mg of potassium ionophore I (Valinomycin, Fluka), 1.2 mg of ETH 5294 that is chromoionophore (N-Octadecanoyl-Nile blue, Fluka), 1 mg of K-TpCIPB (Potassium tetrakis(4-chlorophenyl)borate, Fluka), 14 mg of polyvinyl chrloride (PVC), and 92 μL of DOS (Bis(2-ethylhexyl)sebacate, Fluka) were dissolved in 250 μL of cyclohexanone to prepare an optode mixture. The optode mixture was deposited on the first substrate of the device for measuring electrolyte ions using a drop method and then dried overnight. A solution including 0.3% of sorbitol, 3% of chaps, and 3% of PVP was added to 2-(N-morpholino)ethanesulfonic acid/ N-(2-Acetamido)iminodiacetic Acid (MES/ADA) buffer having a pH of 5.5 and a concentration of 150 mM was coated onto the second substrate of the device for measuring electrolyte ions and dried overnight. The device for measuring electrolyte ions was manufactured by having a surface coated with the optode mixture facing up, placing the first substrate at the bottom, placing the second substrate on top of the first substrate, and locating the spacer in a gap between the first substrate and the second substrate and locking the spacer to parts of the first and second substrate. The device for measuring electrolyte ion concentration was manufactured such that a surface of the second substrate coated with the buffer and a surface of the first substrate coated with the optode mixture were facing each other. A part of the second substrate had holes acting as flowing inlets where a sample may be injected.

The sample was injected into the manufactured device for measuring electrolyte ions by pressuring the sample into the flowing inlet. As the sample passed through the flowing inlet at a pressure of about 8 kPa to about 10 kPa, the sample reacted with the optode coated on the surface of the first substrate. FIG. 10 shows different absorbances measured according to potassium ion concentrations in samples using the device for measuring electrolyte ions. As shown in FIG. 10, at a wavelength of 630 nm, the absorbance decreased as the potassium ion concentration in each of the samples increased.

### EXAMPLE 2

### Comparing Differences in Signal Magnitude of Absorbance at Different Potassium Ion Concentrations Depending on Presence of a Buffer Coating in the Device for Measuring Electrolyte Ions

A mixture having an identical composition to the optode mixture used in Example 1 was prepared and coated on the first substrate with a potassium optode. Two devices for measuring electrolyte ions were then manufactured, one device for measuring electrolyte ions coated with a buffer of 550 mM bis-tris HCl, 0.1% of sorbitol, 0.7% of chaps, and 4% of PVP, and the other device for measuring electrolyte ions without the buffer. By adding potassium ions having a uniform concentration to a serum separation tube (SST) blood sample, differences in the signal magnitudes of absorbance at different potassium concentrations at a wavelength of 630 nm were compared. FIG. 11 shows a difference in the signal magnitudes of absorbance measured according to a potassium concentration in a sample using the device for measuring electrolyte ions coated with a buffer and the device for measuring electrolyte ions without the buffer. As shown in FIG. 11, when an optimal pH environment was maintained by coating the buffer on the second substrate in the device for measuring electrolyte ions, different signal magnitudes resulted at different potassium ion concentrations. On the contrary, the device for measuring electrolyte ions without the buffer did not show variation in the differences in the signal magnitudes of absorbance at different potassium ion concentrations.

### EXAMPLE 3

### Reduced Efficiency of Optode Due to Leaching of Optode Components

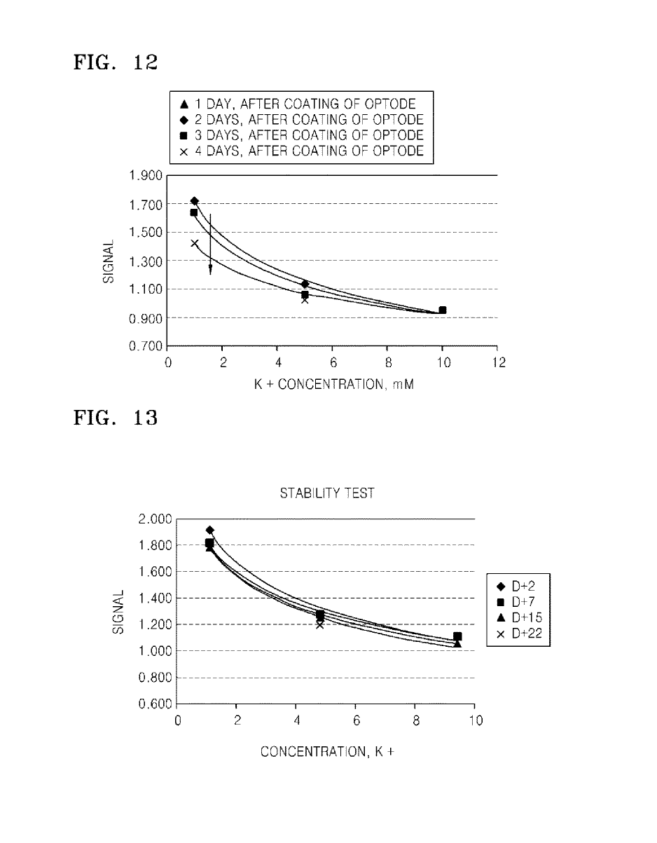

A device for measuring electrolyte ions was manufactured to be identical to the device for measuring electrolyte ions of Example 1. Absorbance at different potassium ion concentrations was measured according to different amounts of time passed after coating the optode. FIG. 12 shows a result of measuring absorbance at different concentrations of potassium ions in a device for measuring electrolyte ions according to passage of time. As shown in FIG. 12, as time passed after coating of the optode, signal magnitude of the absorbance at different potassium ion concentrations decreased. This is because, as time passed after the coating, parts of the optode components leach out to the surroundings.

### EXAMPLE 4

### Improved Stability of the Optode by Replacing Shielding Paint Materials

A shielding paint material was replaced with a polyurethane-based material such as polyurethane, epoxy, or acryl, followed by coating of an optode. Absorbance of the optode at different potassium ion concentrations in a sample injected into the internal cavity of the device was then measured for three weeks by performing the identical processes as in Example 3. FIG. 13 shows a result of measuring the absorbance at different concentrations of potassium ions in a device for measuring electrolyte ions according to passage of time after replacing the shielding paint material. As shown in FIG. 13, as time passed after the coating of the optode, signal magnitude of the absorbance in the sample at different potassium ion concentrations nearly did not decrease. Stability of the polyurethane-based polymer used as a shielding paint material was confirmed. The polyurethane-based polymer was able to maintain the sensitivity of the device for measuring the electrolyte ions because it prevented leaching of optode materials. The stability of the optode was maintained for about three weeks, for example about 22 days.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A method of measuring an electrolyte ion concentration comprising: flowing a sample into a device for measuring electrolyte ions; and detecting a reaction between an optode in the device and the sample,
wherein the device for measuring electrolyte ions comprises one or more optodes disposed on a surface of a first substrate facing one or more buffers disposed on a surface of a second substrate, wherein the one or more optodes comprises a polymer; and one or more of the optodes are surrounded by a shielding material which is hydrophobic compared to the optodes;
wherein the device comprises one or more spacers between the first substrate and the second substrate; the spacers and the first and second substrates together define a cavity or channel; and the one or more optodes and the one or more buffers are within the cavity or channel,
and wherein the one or more optodes each comprise a target ionophore which complexes with the target ion when present, and an indicator ionophore which provides a detectable signal indicating the complexes and the optodes are soluble in organic solvent.

2. The method of claim 1, wherein detecting a reaction between an optode in the device and the sample comprises detecting a color change in the optode.

3. The method of claim 1, wherein the device for measuring electrolyte ions comprises an array of optodes on the surface of the first substrate, and an array of buffers on the surface of the second substrate, wherein the array of optodes faces the array of buffers.

4. The method of claim 1, wherein the buffer is HEPES buffer, MES buffer, ADA buffer, bis-tris buffer, tris buffer, formate buffer, sodium phosphate buffer, citrate buffer, MOPS buffer, ACES buffer, or a mixture thereof.

5. The method of claim 1, wherein the pH of the buffer is about 2 to about 10.

6. The method of claim 1, wherein the buffer further comprises an additive, wherein the additive is sodium dodecyl sulfate (SDS), cetyltrimethylammonium bromide (CTAB), sodium dodecylbenzene sulfate, 3-[(3-cholamidopropyl)dimethylammonio]-1-propanesulfonate (Chaps), 3-[(3-cholamidopropyl)dimethylammonio]-2-hydroxy-1-propanesulfonate (Chapso), Triton X-100 (polyethylene glycol p-(1,1,3,3-tetramethylbutyl)-phenyl ether), Triton X-405 (polyethyleneglycol tert-octylphenyl ether), Triton X-114 (polyethylene glycol p-(1,1,3,3-tetramethylbutyl)-phenyl ether), polyethylene glycol (PEG), sucrose, sorbitol, glycerol, dextran, chitosan, cellulose, lactose, xylitol, mannitol, maltose, inositol, trehalose, glucose, polyvinylpyrrolidone (PVP), polyacrylamide (PAA), polyvinylalcohol (PVA), poly(vinylacetate), poly(methacrylic acid) (PMAA), or a mixture thereof.

7. The method of claim 6, wherein the concentration of the additive is less than or equal to 20% of the buffer based on weight.

8. The method of claim 1, wherein the one or more optodes further comprises a plasticizer.

9. The method of claim 1, wherein the indicator ionophore comprises a chromoionophore or fluoroionophore.

10. The method of claim 1, wherein the organic solvent is cyclohexanone.

11. The method of claim 1, wherein the polymer comprises polyvinyl chloride, and the shielding material comprises a polyurethane-based material.

12. The method of claim 1, wherein the shielding material comprises polyurethane.

13. The method of claim 11, wherein the shielding material comprises polyurethane.

14. The method of claim 1, wherein the polymer comprises polystyrene, polyparamethylsytrene, polymethylmethacrylate, polyethylmethacrylate, polyethylene dimethacrylate, polyvinyldene chloride, polyvinyl chloride, polypropylene, methyl methacrylate-styrene copolymer, polyacolein, polybutadiene, polydivinylbenzene, or polyurethane.
